(19) United States
(12) Patent Application Publication
(10) Pub. No.: US 2008/0199661 A1
(43) Pub. Date: Aug. 21, 2008

(54) Thermally insulated CMC structure with internal cooling

(75) Inventors: Douglas A. Keller, Kalamazoo, MI (US); Malberto F. Gonzalez, Orlando, FL (US); Gary B. Merrill, Orlando, FL (US)

Correspondence Address: Siemens Corporation;Intellectual Property Department, 170 Wood Avenue South, Iselin, NJ, 08830, US

(73) Assignee: Siemens Power Generation, Inc.

(21) Appl. No.: 11/707,191

(22) Filed: Feb. 15, 2007

(51) Int. Cl. B32B 3/20

(52) U.S. Cl. 428/188

(57) ABSTRACT

An insulated CMC structure (20A) formed of a CMC layer (22A), a thermal insulation layer (24A) applied to a front surface (30A) of the CMC layer (22A), and cooling channels (28A) formed along the interface (26A) between the CMC layer and the thermal insulation layer, thus directly cooling the thermally critical area of the interface. Embodiments include cooling channels in direct contact with both layers (FIG. 1); cooling channels in one layer and tangent to the other layer (FIGS. 4, 5 and 9); cooling channels in the CMC layer with an intervening wall (36D, 36E) that bulges into the thermal insulation layer for improved bonding thereof (FIGS. 6, 7); and cooling channels formed in ceramic tubes (38F of FIG. 8).

### FIELD OF THE INVENTION

The invention relates to ceramic matrix composites (CMC), and more particularly to an internally air-cooled CMC wall structure with a ceramic thermal insulation layer.

### BACKGROUND OF THE INVENTION

Engine components in the hot gas flow of modern combustion turbines are required to operate at ever-increasing temperatures as engine efficiency requirements continue to advance. Ceramics typically have higher heat tolerance and lower thermal conductivities than metals. For this reason, ceramics have been used both as structural materials in place of metallic materials and as coatings for both metal and ceramic structures. Ceramic matrix composite (CMC) wall structures with ceramic insulation outer coatings, such as described in commonly owned U.S. Pat. No. 6,197,424, have been developed to provide components with the high temperature stability of ceramics without the brittleness of monolithic ceramics.

Film cooling is sometimes used to reduce the temperature of the hot working gas along the surface of components, thereby lowering the heat load on the component. This requires a large volume of cooling air to be supplied through many film channels and outlets across the width and length of the component surface. Convective or impingement cooling on back surfaces of component walls is also used to remove heat passing through the walls. However, backside cooling efficiency is reduced by the low thermal conductivity of ceramic material and by the fact that the wall thickness of a CMC structure may be thicker than in an equivalent metal structure.

Commonly owned U.S. Pat. No. 6,709,230 describes cooling channels in a ceramic core of a gas turbine vane behind an outer CMC airfoil shell, and commonly owned U.S. Pat. No. 6,746,755 uses ceramic matrix composite cooling tubes between CMC face sheets to form a CMC wall structure with internal cooling channels. Further improvements in the cooling of a ceramic matrix composite wall structure are desired to support further increases in the firing temperatures of advanced gas turbine engines.

### BRIEF DESCRIPTION OF THE DRAWINGS

The invention is explained in the following description in view of the drawings that show:

FIG. 1 is a sectional view of a CMC structure with a thermal insulation layer and cooling channels in an exemplary embodiment A.

FIG. 2 is a sectional view taken along line 2-2 of FIG. 1.

FIG. 3 is a sectional view of a CMC structure with a thermal insulation layer, with cooling channels formed by rods of fugitive material during lay-up.

FIG. 4 is a sectional view of a CMC structure with a thermal insulation layer and cooling channels in an exemplary embodiment B.

FIG. 5 is a sectional view of a CMC structure with a thermal insulation layer and cooling channels in an exemplary embodiment C.

FIG. 6 is a sectional view of a CMC structure with a thermal insulation layer and cooling channels in an exemplary embodiment D.

FIG. 7 is a sectional view of a CMC structure with a thermal insulation layer and cooling channels in an exemplary embodiment E.

FIG. 8 is a sectional view of a CMC structure with a thermal insulation layer and cooling channels in an exemplary embodiment F.

FIG. 9 is a sectional view of a CMC structure with a thermal insulation layer and cooling channels in an exemplary hybrid embodiment G that combines embodiments B and C.

### DETAILED DESCRIPTION OF THE INVENTION

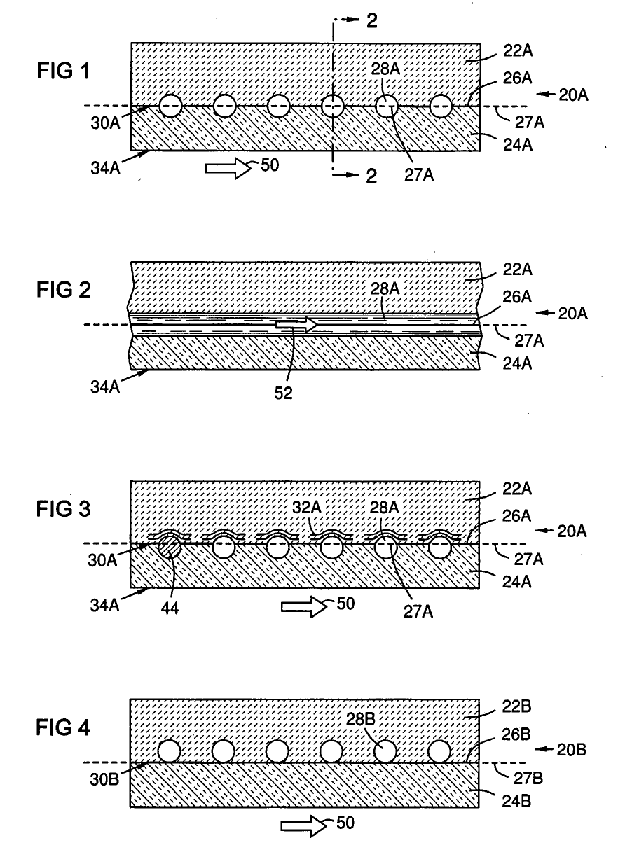

FIG. 1 illustrates an insulated CMC structure 20A in an exemplary embodiment A with a CMC layer 22A, a thermal insulation layer 24A applied to a front surface 30A of the CMC layer 22A, and an interface 26A between the layers 22A, 24A. Cooling channels 28A are formed along the interface 26A, and are generally parallel to and intersect a plane 27A of the interface 26A along at least a part of the interface 26A, thus cooling the thermally critical area of the interface 26A. Each cooling channel 28A may be partly within the CMC layer 22A and partly within the thermal insulation layer 24A, and may be in direct contact with both layers 22A, 24A. Advantageously, this cooling channel location provides for heat transfer directly from the interface 26A to a cooling fluid passing through the cooling channel 28A without the need for conveying the heat through a full or partial thickness of the CMC layer 22A.

FIG. 2 shows a sectional view along a cooling channel 28A of FIG. 1. During operation of a gas turbine, a hot working gas 50 flows along a front surface 34A of the CMC structure 20A. When a cooling fluid 52 flows through the cooling channel 28A it draws heat directly from the area of the interface 28A without the need to transfer that heat energy through the thickness of the CMC layer 22A. The cooling channel 28A is shown here as a straight cylindrical shape for clarity, but is not limited to this. It may have other cross sectional shapes, and it may follow any desired curve, for example an S-shape.

FIG. 3 illustrates a method of forming the insulated CMC structure 20A by pressing a rod 44 or other form made of a fugitive material into the front surface 30A of the CMC layer 22A during a wet lay-up stage, then partially curing or drying the CMC layer 22A, then applying the thermal insulation layer 24A, then fully curing the insulated CMC structure 20A. The final curing temperature may be high enough to burn away the fugitive rod 44, or the rod may be dissolved chemically to leave the channels 28A. Ceramic fibers 32A in the CMC layer 22A may be curved (but not separated) by the rod 44 as shown. Alternately the channels 28A may be machined after curing, thus cutting some fibers 32A.

If the CMC structure 20A forms a turbine blade, the cooling fluid 52 may enter the channels 28A by means of a device that injects cooling air into passages in the turbine shaft. It flows through the turbine shaft, then outward through passages in the turbine disks, then though the channels 28A in the blade. It may exit the outer surface of the blade into the working gas 50, providing film cooling, or it may be routed elsewhere as known in the art. Other CMC components may use other fluid routing as known in the art.

FIG. 4 illustrates an insulated CMC structure 20B in an exemplary embodiment B with a CMC layer 22B, a thermal insulation layer 24B applied to a front surface 30B of the CMC layer 22B, and an interface 26B between the layers 22B, 24B. Cooling channels 28B are formed along the interface 26B, and intersect a plane 27B of the interface 26B along at least a part of the interface 26B, thus cooling the thermally critical area of the interface 26B. Each cooling channel 28B may be within the CMC layer 22B and essentially tangent to the thermal insulation layer 24B, and may be in direct contact with both layers 22B, 24B.

FIG. 5 illustrates an insulated CMC structure 20C in an exemplary embodiment C with a CMC layer 22C, a thermal insulation layer 24C applied to a front surface 30C of the CMC layer 22C, and an interface 26C between the layers 22C, 24C. Cooling channels 28C are formed along the interface 26C, and intersect a plane 27C of the interface 26C along at least a part of the interface 26C, thus cooling the thermally critical area of the interface 26C. Each cooling channel 28C may be within the thermal insulation layer 24C and essentially tangent to the CMC layer 22C, and may be in direct contact with both layers 22C, 24C.

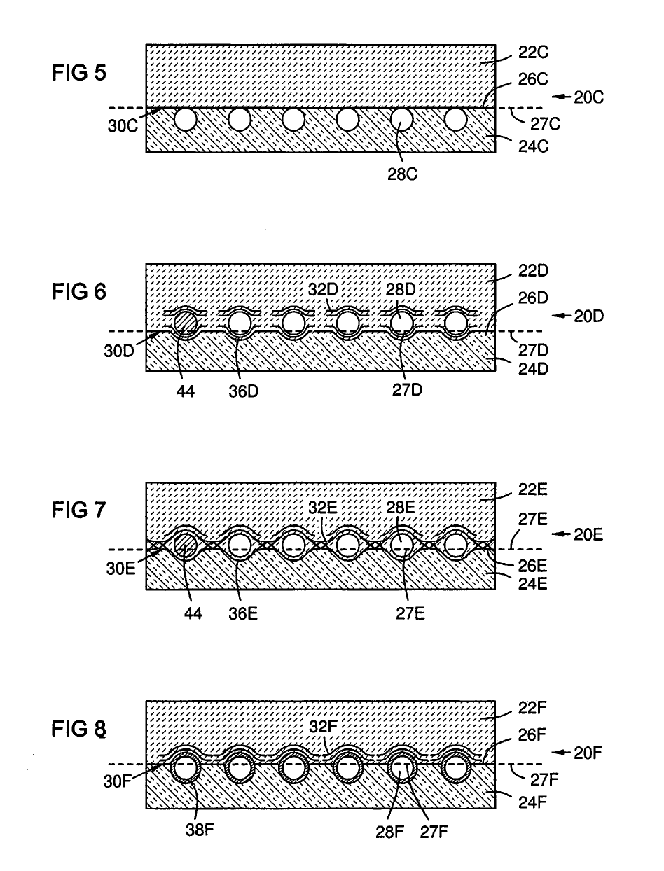

FIG. 6 illustrates an insulated CMC structure 20D in an exemplary embodiment D with a CMC layer 22D, a thermal insulation layer 24D applied to a front surface 30D of the CMC layer 22D, and an interface 26D between the layers 22D, 24D. Cooling channels 28D are formed along the interface 26D, and intersect a plane 27D of the interface 26D along at least a part of the interface 26D, thus cooling the thermally critical area of the interface 26D. Each cooling channel 28D may be formed by a fugitive rod 44 or other form inserted within the CMC layer 22D and covered in CMC fibers 32D, causing the fibers 32D to bulge forward from the front surface 30D of the CMC layer 22D around each rod 44. This creates an uneven CMC front surface 30D that increases a bonding area for the thermal insulation layer 24D, thus improving the bond strength. After the fugitive rods 44 are burned or dissolved away, the resulting channels 28D may be in direct contact with the CMC layer 22D and in indirect contact with the thermal insulation layer 24D via thin intervening walls 36D of CMC, thereby still providing direct cooling along the plane 27D of interface 26D without the need to transfer heat across a thickness of the CMC layer 22D. These walls 36D may be limited in thickness to less than 25% of a diameter or maximum cross sectional dimension of a channel 28D for maximum cooling effectiveness in one embodiment.

FIG. 7 illustrates an insulated CMC structure 20E in an exemplary embodiment E with a CMC layer 22E, a thermal insulation layer 24E applied to a front surface 30E of the CMC layer 22E, and an interface 26E between the layers 22E, 24E. Cooling channels 28E are formed along the interface 26E, and intersect a plane 27E of the interface 26E along at least a part of the interface 26E, thus cooling the thermally critical area of the interface 26E. Each cooling channel 28E may be formed by a fugitive rod 44 or other form around which CMC fibers 32E are woven in a continuous weave that causes the fibers 32E to bulge forward from the front surface 30E of the CMC layer 22E around each rod 44. This creates an uneven CMC front surface 30E that increases a bonding area for the thermal insulation layer 24E, thus improving the bond strength. After the fugitive rods are burned or dissolved away, the resulting channels 28E may be in direct contact with the CMC layer 22E and in indirect contact with the thermal insulation layer 24E via thin intervening walls 36E of CMC, thereby providing direct cooling along the plane 27E of interface 26E. These walls 36E may be limited in thickness to less than 25% of a diameter or maximum cross sectional dimension of a channel 28E for maximum cooling effectiveness in one embodiment.

FIG. 8 illustrates an insulated CMC structure 20F in an exemplary embodiment F with a CMC layer 22F, a thermal insulation layer 24F applied to a front surface 30F of the CMC layer 22F, and an interface 26F between the layers 22F, 24F. Cooling channels 28F are formed along the interface 26F, and intersect a plane 27F of the interface 26F along at least a part of the interface 26F, thus cooling the thermally critical area of the interface 26F. Each cooling channel 28F may be formed by a hollow ceramic tube 38F, such as a monolithic ceramic or CMC tube, pressed into the front surface 30F of the CMC layer 22F during a lay-up stage. The thermal insulation layer 24F is then applied. The tubes 38F provide additional structural stability to the channels 28F, and additional bonding surface area between the CMC layer 22F and the thermal insulation layer 24F, thus improving the bond strength. The resulting channels 28F are in indirect contact with the CMC layer 22F and with the thermal insulation layer 24F via the walls of the tubes 38F, thereby providing direct cooling along the plane 27F of interface 26F. Ceramic fibers 32F in the CMC layer 22F may be curved (but not cut) by the tube 38F as shown. Alternately, the tubes 38F may be inserted into holes machined into the insulated CMC structure 20F after partial curing thereof. Alternately, grooves may be machined in the front surface 30F of the CMC layer to receive the tubes 38F before applying the thermal insulation 24F. The walls of the tubes 38F may be limited in thickness to less than 25% of a diameter or maximum cross sectional dimension of a channel 28F for maximum cooling effectiveness in one embodiment.

Fugitive rods 44 or other forms may be used to create the channels 28A, 28B, 28C, 28D, 28E in any of the embodiments herein, except in embodiment F in which a tube 38F may be used. In embodiment F fugitive rods 44 may be used as another alternative to create holes in the insulated CMC structure to receive the tubes 38F. Machining may alternately be used to form the channels 28A, 28B, or 28C.

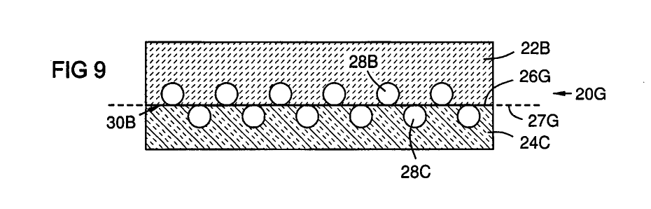

Hybrid or combined forms of the above embodiments are possible. For example, FIG. 9 illustrates an insulated CMC structure 20G in an exemplary embodiment G, which is a hybrid combination based on FIGS. 4 and 5 having a front row of channels 28C and a back row of channels 28B, the two rows offset from each other horizontally. The cooling channels 28B, 28CF are formed along the interface 26G, and intersect a plane 27G of the interface 26G along at least a part of the interface 26G, thus cooling the thermally critical area of the interface 26G. Hollow tubes formed of any appropriate material may be used to define some or all of the cooling channels for any particular application. The tubes may have a straight longitudinal axis or may be curved along at least a portion of their lengths as may be required to follow a contour of the interface.

As used herein, the term “plane” of the interface is a flat plane of the front surface of the CMC layer if said front surface is planar. If the insulated CMC structure is curved, as in a turbine blade or vane airfoil, then a “plane” of the interface may be understood to be the curved surface of the front surface of the CMC layer. If the front surface of the CMC layer is uneven, as described for embodiments D and E, then a “plane” of the interface is the plane or surface curve defined by connecting the minima of the uneven front surface; in other words, the geometry of the “plane” in embodiments D and E excludes the bulging intervening walls. As used herein, the term “along the interface” means generally parallel to the plane of the interface over at least a part of the interface and either intersecting or essentially tangent to the plane of the interface. As used herein, a cooling channel being “in contact” with a layer means that the channel is either in direct contact with the layer, with no intervening material as in embodiments A, B, C, and G, or is in indirect contact with one or both layers via only an intervening wall as in embodiments D, E, and F. As used herein, the “direct transfer of heat” refers to a cooling capacity applied along the plane of the interface for cooling without the need for conducting heat through a thickness of the CMC layer.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A structure comprising:
a CMC layer comprising a front surface;
a thermal insulation layer on the front surface of the CMC layer; and
a cooling channel disposed along a plane of an interface between the CMC layer and the thermal insulation layer.

2. The structure of claim 1, wherein the cooling channel is partly within the CMC layer and partly within the thermal insulation layer.

3. The structure of claim 1, wherein the cooling channel is formed by a tube of monolithic ceramic or CMC disposed at the interface, the tube comprising walls in contact with both layers along at least part of the interface.

4. The structure of claim 1, wherein the cooling channel is formed by pressing a form into the front surface of the CMC layer during a lay-up stage, thereby positioning the cooling channel partly within the CMC layer and partly within the thermal insulation layer, and wherein fibers of the CMC layer are curved around the cooling channel without being cut.

5. The structure of claim 4, wherein the form comprises a fugitive material that is later removed to define the cooling channel.

6. The structure of claim 4, wherein the form comprises a hollow ceramic cooling tube.

7. The structure of claim 1, wherein the cooling channel is within the CMC layer and is generally tangent to the interface between the CMC layer and the thermal insulation layer along at least part of the interface.

8. The structure of claim 1, wherein the cooling channel is within the thermal insulation layer and is approximately tangent to the interface between the CMC layer and the thermal insulation layer along at least part of the interface.

9. The structure of claim 1, wherein the cooling channel is formed by inserting a form into the CMC layer during a lay-up stage, thus covering the form in fibers of the CMC layer, and causing the fibers to bulge forward around each form without being cut and providing an increased bonding surface area on the front surface of the CMC layer for the thermal insulation layer.

10. The structure of claim 9, wherein the form comprises a fugitive material.

11. The structure of claim 9, wherein the form comprises a hollow tube.

12. The structure of claim 1, wherein the cooling channel is formed by weaving fibers of the CMC layer around a form made of a fugitive material during a CMC weaving stage, causing the fibers to bulge forward from the front surface of the CMC layer around each form without being cut and providing an increased bonding surface area on the front surface of the CMC layer.

13. A structure comprising:
a layer of CMC material;
a layer of ceramic insulating material comprising a back surface disposed on a front surface of the CMC material and comprising a front surface adapted to be heated by a high temperature gas; and
a means for removing heat from an interface between the CMC material and the ceramic insulating material without the need to transfer the heat through a thickness of the CMC material.

14. The structure of claim 13, wherein the means for removing heat comprises a cooling channel formed in the layer of CMC material without cutting any fiber of the CMC material.

15. The structure of claim 13, wherein the means for removing heat comprises a tube disposed along the interface.

16. The structure of claim 13, wherein the means for removing heat comprises a cooling channel formed in a weave of fibers of the CMC material along the interface.

17. The structure of claim 13, wherein the means for removing heat comprises a hole machined through fibers of the CMC material along the interface.

18. The structure of claim 13, wherein the means for removing heat comprises a hole machined through the ceramic insulating material along the back surface of the ceramic insulating material.

19. A structure comprising:
a layer of CMC material;
a layer of ceramic insulating material disposed on a surface of the CMC material and defining an interface there between; and
a cooling tube disposed proximate the interface between the CMC material and the ceramic insulating material.

20. The structure of claim 19, wherein the cooling tube comprises a ceramic material in contact with both the layer of CMC material and the layer of ceramic insulating material.
